(19) United States
(12) Patent Application Publication
(10) Pub. No.: US 2009/0306420 A1
(43) Pub. Date: Dec. 10, 2009

(54) PROCESS FOR PREPARING COPPER-COMPRISING METAL ORGANIC FRAMEWORKS

(75) Inventors: Markus Schubert, Ludwigshafen (DE); Faruk Oezkirim, Ludwigshafen (DE); Christoph Kiener, Weisenheim am Sand (DE); Ulrich Mueller, Neustadt (DE); Markus Tonigold, Blaustein (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/375,218

(22) PCT Filed: Jul. 13, 2007
(86) PCT No.: PCT/EP07/57252

§ 371 Date: Jan. 27, 2009

(30) Foreign Application Priority Data
Jul. 27, 2006 (EP) 06117958.6

(51) Int. Cl. C07F 1/08

(52) U.S. Cl. 556/115

(57) ABSTRACT

The present invention relates to a process for preparing a porous metal organic framework comprising a first and at least one second at least bidentate organic compound coordinated to at least one copper ion, which comprises the steps
(a) reaction of a reaction mixture in the liquid phase comprising at least one copper compound and the first at least bidentate organic compound to form an intermediate complex comprising the at least one copper ion and the first at least bidentate organic compound, with the first at least bidentate organic compound being derived from a dicarboxylic acid and having a skeleton which is a hydrocarbon, and
(b) reaction of the intermediate complex with the at least second at least bidentate organic compound, with the at least second at least bidentate organic compound being an optionally substituted monocyclic, bicyclic or polycyclic saturated or unsaturated hydrocarbon in which at least two ring carbons have been replaced by heteroatoms selected from the group consisting of N, O and S,

wherein the reaction mixture in step (a) comprises less than a 3-fold excess of formic acid based on the copper of the copper compound used.

The present invention relates to a process for preparing a porous metal organic framework comprising at least two organic compounds which are coordinated to copper ions.

Porous metal organic frameworks are generally known in the prior art and have been proposed for numerous applications. Such applications are, for example, the storage, separation or controlled release of chemical substances, for example gases, or in the field of catalysis. Here, the porosity of the metal organic framework in particular plays a decisive role. It is likewise important in the preparation of such metal organic frameworks to provide processes which make it possible to provide frameworks with high reproducibility in respect of their properties, in particular their specific surface area.

Porous metal organic frameworks are typically formed by a metal ion and a polydentate ligand, resulting in formation of a multidimensional framework which either extends infinitely as a polymer or, depending on the choice of the ligands, as polyhedron.

One-, two- and three-dimensional frameworks are all possible here.

Depending on the application, the efficiency of the porous metal organic framework can be optimized by appropriate choice of the ligand and of the metal ion.

There are therefore numerous proposals in the literature which describe many ligands and metals.

An interesting group of porous metal organic frameworks is based on copper as metal ion, with two organic compounds being used as ligand. Here, the first organic compound is typically a dicarboxylic acids with which the copper can form a two-dimensional porous metal organic framework. Addition of a further ligand, which is typically amine-based, enables a three-dimensional framework structure to be formed by coordination of this second compound as a result of this second compound forming bridges between the formerly two-dimensional layers by complexation of the copper.

An example of such a system is a copper complex with terephthalic acid and triethylenediamine.

To prepare these porous metal organic frameworks, a copper compound, typically copper sulfate pentahydrate, is used as starting material. In addition, terephthalic acid is added, with the reaction in this step taking place in the presence of formic acid.

The function of the formic acid is to allow formation of an appropriate metal organic framework which is then brought into contact with triethylenediamine in the second step in order to form the above-described porous metal organic framework.

Here, the formic acid serves as a type of auxiliary for the precipitation, but in the prior art is employed in a large excess based on the copper used.

Thus, for example, JP-A 2005/093181 describes the preparation of Cu-BDC-TEDA with the formic acid being used in a 95-fold excess. The framework obtained in this way is suitable for the storage of gases, in particular hydrogen. However, JP-A 2005/093181 proposes using heterocyclic ligands based on tetrazine in place of the aromatic ligand terephthalic acid. As a result, the reaction with triethylenediamine can be carried out successfully without use of formic acid. This is considered to be required only when no heterocyclic ligand is used. The reason for this can thus be that the formation of a first intermediate complex is more readily possible, so that the subsequent reaction with triethylenediamine is less problematical than would be possible if, for example, terephthalic acid were to be used.

The preparation of Cu-BDC-TEDA as porous metal organic framework is also described by K. Seki et al., J. Phys. Chem. B 106 (2002), 1380-1385. Here, a 43-fold excess of formic acid over copper is used.

Finally, JP-A 2004/305985 describes the above-described metal organic framework, with formic acid being used in a 7-fold excess in this case. The material obtained is suitable for the storage of liquefied gas.

Although there are numerous processes for preparing the above-described metal organic frameworks, there continues to be a need for alternative processes in which, in particular, scale-up is possible and which are suitable for providing the desired metal organic framework in a reproducible way, in particular in respect of its specific surface area.

It is therefore an object of the present invention to provide such a process.

This object is achieved by a process for preparing a porous metal organic framework comprising a first and at least one second at least bidentate organic compound coordinated to at least one copper ion, which comprises the steps
(a) reaction of a reaction mixture in the liquid phase comprising at least one copper compound and the first at least bidentate organic compound to form an intermediate complex comprising the at least one copper ion and the first at least bidentate organic compound, with the first at least bidentate organic compound being derived from a dicarboxylic acid and having a skeleton which is a hydrocarbon, and
(b) reaction of the intermediate complex with the at least second at least bidentate organic compound, with the at least second at least bidentate organic compound being an optionally substituted monocyclic, bicyclic or polycyclic saturated or unsaturated hydrocarbon in which at least two ring carbons have been replaced by heteroatoms selected from the group consisting of N, O and S,
   wherein the reaction mixture in step (a) comprises less than a 3-fold excess of formic acid based on the copper of the copper compound used.

It has surprisingly been found that, in particular, a reduced usage of formic acid and very preferably omission of formic acid in the preparation of the above-described metal organic frameworks leads to these frameworks being obtained with high specific surface areas and a higher reproducibility of such frameworks being able to be achieved. The assumption in the prior art that the presence of formic acid or other monocarboxylic acids is necessary to be able to obtain the above-described porous metal organic frameworks in an appropriate way can be overcome by the present process according to the invention.

The process of the invention for preparing a porous metal organic framework comprising a first and at least one second at least bidentate organic compound coordinated to at least one copper ion comprises at least two steps.

In step a), a reaction mixture comprising at least one copper compound and the first at least bidentate organic compound is reacted in the liquid phase. The reaction forms an intermediate complex which comprises the at least one copper ion and the first at least bidentate organic compound.

The copper compound used is a copper(I) or copper(II) compound. It is preferably a copper(II) compound. Particular preference is given to the copper compound being present in the form of a salt. In particular, this salt is an inorganic copper salt.

The copper(II) compound is preferably selected from the group consisting of copper(II) sulfate, bromide, chloride, carbonate and hydrates thereof. It is likewise possible to use copper(II) nitrate or its hydrate.

Particular preference is given to copper(II) sulfate and its monohydrate or pentahydrate.

Preferred copper(I) compounds are likewise those compounds listed for copper(II), i.e. sulfate, bromide, chloride, carbonate, nitrate and hydrates thereof.

In contrast to the prior art, less than a 3-fold excess of formic acid based on the copper of the copper compounds used is employed in step a) of the process of the invention for preparing a porous metal organic framework.

For the purposes of the present invention, the term “excess” is the ratio of the molar amount of formic acid, formate or the sum of the molar amounts of formic acid and formate to the molar amount of copper of the copper compound when this ratio is >1. Accordingly, a substoichiometric amount is present when the ratio is <1. According to the present invention, a substoichiometric amount is thus present when the value for the excess is <1.

For the purposes of the present invention, the excess has to be less than a 3-fold excess of formic acid based on the copper of the copper compounds used. The excess is more preferably less than a 2-fold excess. It is even more preferred for a substoichiometric amount of formic acid based on the copper used to be present.

Even more preferably, no formic acid is used in step (a) of the process of the invention for preparing a porous metal organic framework.

For the purposes of the present invention, the expression “no formic acid” means that the ratio of the molar amount of formic acid, formate or the sum of the molar amounts of formic acid and formate to the molar amount of copper of the copper compound has a value which is <1000 ppm, preferably less than 10 ppm, even more preferably less than 1 ppm.

Furthermore, preference is given, for the purposes of the present invention, to the proportion of formic acid being less than 2% by weight, more preferably less than 1% by weight, even more preferably less than 0.1% by weight and in particular less than 0.01% by weight, in each case based on the total weight of the reaction mixture.

In particular, the expression “no formic acid” means that the presence of formic acid or formate cannot be detected by at least one detection method which is suitable in principle. Various customary detection methods can be used for detecting formic acid. Examples are UV spectroscopy, IR spectroscopy, nuclear magnetic resonance spectroscopy, mass spectrometry, flame ionization detection and further methods.

In addition, further preference is given to not only formic acid or formate or both not being present in the amounts indicated above in the process of the invention for preparing a porous metal organic framework but other monocarboxylic acids or their carboxylates or both being present in the molar amounts indicated for formic acid.

Monocarboxylic acids which may be mentioned by way of example are benzoic acid, acetic acid, propionic acid, butyric acid, acrylic acid and methacrylic acid.

In step a) of the process of the invention for preparing a porous metal organic framework, the reaction takes place in the presence of a first at least bidentate organic compound.

Here, the first at least bidentate organic compound is derived from a dicarboxylic acid and has a skeleton which is a hydrocarbon.

For the purposes of the present invention, the term “derived” means that the dicarboxylic acid can be present in partially deprotonated or fully deprotonated form in the framework. Furthermore, the dicarboxylic acid can comprise a substituent or a plurality of independent substituents. Examples of such substituents are —OH, —NH₂, —OCH₃, —CH₃, —NH(CH₃), —N(CH₃)₂, 'CN and halides. Furthermore, the term “derived” means, for the purposes of the present invention, that the dicarboxylic acid can also be present in the form of the corresponding sulfur analogues. Sulfur analogues are the functional groups —C(═O)SH and its tautomer and C(═S)SH which can be used in place of one or more carboxylic acid groups. In addition, the term “derive” means, for the purposes of the present invention, that one or more carboxylic acid functions can be replaced by a sulfonic acid group (—SO₃H). In addition, a sulfonic acid group can likewise be present in addition to the two carboxylic acid functions.

In addition to the abovementioned functional groups, the dicarboxylic acid comprises an organic skeleton or an organic compound to which these are bound. The abovementioned functional groups can in principle be bound to any organic compound as long as it is ensured that this organic compound having functional groups is capable of forming the coordinate bond to produce the framework and is a hydrocarbon.

The first organic compound is preferably derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. Furthermore, the aliphatic compound or the aliphatic part of the both aliphatic and aromatic compound preferably comprises from 1 to 18, more preferably from 1 to 14, more preferably from 1 to 13, more preferably from 1 to 12, more preferably from 1 to 11 and particularly preferably from 1 to 10, carbon atoms, for example 1, 2, 3, 4, 5, 6, 7, 8, 9 or 10 carbon atoms. Particular preference is given to, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings being able to be present in fused form. The aromatic compound or the aromatic part of the both aliphatic and aromatic compound particularly preferably has one, two or three rings, with one or two rings being particularly preferred. Further preference is given to the aromatic compound or the aromatic part of the both aromatic and aliphatic compound comprising one or two C₆ rings, with in the case of two rings these being able to be present either separately from one another or in fused form. Particular mention may be made of benzene, naphthalene, pyrene and dihydropyrene as aromatic compounds.

Particularly preferred hydrocarbons are benzene, napththalene, biphenyl, pyrene, dihydropyrene and ethene.

For example, the first organic compound is derived from a dicarboxylic acid such as oxalic acid, succinnic acid, tartaric acid, 1,4-butanedicarboxylic acid, 1,4-butenedicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 1,3-butadiene-1,4-dicarboxylic acid, 1,4-benzenedicarboxylic acid, 4,4′-diaminophenylmethane-3,3′-dicarboxylic acid, perylene-3,9-dicarboxylic acid, perylenedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, benzidine-3,3′-dicarboxylic acid, 1,1′-binaphthyldicarboxylic acid, 1,4,5,6,7,7-hexachloro-5-norbornene-2,3-dicarboxylic acid, phenylinedanedicarboxylic acid, 1,4-cyclohexanedicarboxylic acid, naphthalene-1,8-dicarboxylic acid, hydroxybenzophenonedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, anthracene-2,3-dicarboxylic acid, 5-tert-butyl-1,3-benzenedicarboxylic acid, 4-cyclohexene-1,2-dicarboxylic acid, tetradecanedicarboxylic acid, 1,7-heptadecanedicarboxylic acid, 5-hydroxy-1,3-benzenedicarboxylic acid, 2,5-dihydroxybenzene-1,4-dicarboxylic acid. 1-nonene-6,9-dicarboxylic acid, eicosenedicarboxylic acid, 4,4′-dihydroxydiphenylmethane-3,3′-dicarboxylic acid, cyclohexene-2,3-dicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid or camphordicarboxylic acid.

Furthermore, the first organic compound is more preferably one of the dicarboxylic acids mentioned above by way of example as such.

Particularly preferred dicarboxylic acids are terephthalic acid, 1,4-naphthalenedicarboxylic acid, 1,5-naphthalenedicarboxylic acid, 2,6-naphthalenedicarboxylic acid, 1,5′-biphenyldicarboxylic acid, 4,4′-biphenyldicarboxylic acid, fumaric acid, isophthalic acid. Very particular preference is given to terephthalic acid and 2,6-naphthalenedicarboxylic acid.

The reaction in step (a) of the process of the invention for preparing a porous metal organic framework gives an intermediate complex which comprises the first at least bidentate organic compound and the at least one copper ion.

After the preparation, the crystalline porous intermediate complex is generally present in the form of primary crystals in the mother liquor.

After the preparation of the intermediate complex, the framework solid of the intermediate complex can be separated from its mother liquor. This separation can in principle be carried out by all suitable methods. The intermediate is preferably separated off by solid-liquid separation, centrifugation, extraction, filtration, membrane filtration, crossflow filtration, diafiltration, ultrafiltration, flocculation using flocculants such as nonionic, cationic and/or anionic auxiliaries, pH shift by addition of additives such as salts, acids or bases, flotation, spray drying, spray granulation, or evaporation of the mother liquor at elevated temperatures and/or under reduced pressure and concentration of the solid.

The separation can be followed by at least one additional washing step, at least one additional drying step and and/or at least one additional calcination step.

If step (a) in the process of the invention is followed by at least one washing step, washing is preferably carried out using at least one of the solvents used in the reaction in step (a).

Suitable solvents for step (a) of the process of the invention are, for example, N,N-dimethylformamide (DMF), N,N-diethylformamide (DEF) or N,N-dimethylacetamide (DMAc). These can preferably also be used as a mixture with alcohols such as methanol, ethanol, n-propanol, i-propanol, ketones such as acetone, methyl ethyl ketone or water.

Preference is given to introducing the first at least bidentate organic compound in DMF, DEF or DMAc into the reaction mixture and introducing the copper compound together with the alcohol, ketone or water into the reaction mixture so that the liquid phase comprises the abovementioned mixtures.

Preference is also given to alcohol mixtures; particular preference is given to the mixture DMF/methanol.

If step a) in the process of the invention is, if appropriate after at least one washing step, followed by at least one drying step, the framework solid is generally dried at temperatures in the range from 20 to 200° C., preferably in the range from 25 to 120° C. and particularly preferably in the range from 56 to 65° C.

Drying under reduced pressure is likewise preferred, with the temperatures generally being able to be chosen so that the at least one washing liquid is at least partly removed, preferably essentially completely removed, from the crystalline porous metal organic framework and the framework structure is at the same time not destroyed.

Temperatures here are, for example, in the range from 40° C. to 200° C., preferably in the range from 50° C. to 120° C. and in particular in the range from 20° C. to 110° C.

The drying time is generally in the range from 0.1 to 15 h, preferably in the range from 0.2 to 5 h and particularly preferably in the range from 0.5 to 1 h.

The if appropriate at least one washing step and if appropriate at least one drying step in step (a) can be followed by at least one calcination step in which the temperatures are preferably chosen so that the structure of the framework is not destroyed.

It is, for example, possible, in particular by means of washing and/or drying and/or calcination, for at least one template compound which may have been used for the electrochemical preparation according to the invention of the framework to be at least partly, preferably essentially quantitatively, removed.

As indicated above, in step (b) of the process of the invention, either the unisolated intermediate complex is reacted with a second organic compound or the intermediate is separated off and reacted with the second organic compound, preferably in a solvent. This reaction is typically carried out in a manner analogous to step (a). This also applies to a subsequent work-up.

Preference is given to the intermediate complex being obtained by separating off the mother liquor and being used without further work-up in step (b).

The reaction in step (b) is preferably carried out in a solvent or solvent mixture. Here, it is possible to use liquid phases as can be used for step (a) of the process of the invention. Apart from the intermediate complex and the second organic compound, further additives can participate in the reaction.

Suitable solvents are alcohols such as methanol, ethanol, n-propanol, i-propanol or ketones such as acetone, methyl ethyl ketone. Preference is given to methanol.

What has been said in respect of formic acid or monocarboxylic acid for step (a) preferably applies step (b).

In step (b) of the process of the invention, the intermediate complex is reacted with the at least second at least bidentate organic compound, with the at least second at least bidentate organic compound being an optionally substituted monocyclic, bicyclic or polycyclic saturated or unsaturated hydrocarbon in which at least two ring carbons have been replaced by heteroatoms selected from the group consisting of N, O and S.

The second organic compound preferably comprises at least nitrogen as ring atom; more preferably only nitrogen occurs as heteroatom.

The hydrocarbon can be unsubstituted or substituted. If more than one substituent is present, the substituents can be identical or different. Substituents can be, independently of one another, phenyl, amino, hydroxy, thio, halogen, pseudohalogen, formyl, amide, an acyl having an aliphatic saturated or unsaturated hydrocarbon radical having from 1 to 4 carbon atoms and an aliphatic branched or unbranched saturated or unsaturated hydrocarbon having from 1 to 4 carbon atoms. If the substituents comprise one or more hydrogen atoms, each of these can independently also be replaced by an aliphatic branched or unbranched saturated or unsaturated hydrocarbon having from 1 to 4 carbon atoms.

Halogen can be fluorine, chlorine, bromine or iodine. Pseudohalogen is, for example, cyano, cyanato or isocyanato.

An aliphatic branched or unbranched saturated or unsaturated hydrocarbon having from 1 to 4 carbon atoms is, for example, methyl, ethyl, n-propyl, i-propyl, n-butyl, i-butyl, t-butyl, vinyl, ethynyl or allyl.

An acyl having an aliphatic saturated or unsaturated hydrocarbon radical having from 1 to 4 carbon atoms is, for example, acetyl or ethylcarbonyl.

Preference is given to the second organic compound being unsubstituted or having one substituent which is methyl or ethyl.

The monocyclic, bicyclic or polycyclic hydrocarbon preferably has 5- or 6-membered rings, more preferably 6-membered rings.

Furthermore, preference is given to the at least two heteroatoms being nitrogen.

The second organic compound more preferably has precisely two heteroatoms, preferably nitrogen.

If the hydrocarbon has a 6-membered ring in which two heteroatoms, preferably nitrogen, are present, these are preferably in the para position relative to one another.

Furthermore, preference is given to the second organic compound being able to be derived from an unsaturated hydrocarbon which is aromatic or fully saturated. If the second organic compound has more than one ring, preference is given to at least one ring being aromatic.

The monocyclic hydrocarbon from which the second organic compound is derived is, for example, cyclobutane, cyclobutene, cyclobutadiene, cyclopentane, cyclopentene, cyclopentadiene, benzene, cyclohexane or cyclohexene. The monocyclic hydrocarbon from which the second organic compound is derived is preferably benzene or cyclohexane.

The bicyclic hydrocarbon from which the second organic compound is derived can, for example, comprise two rings which are linked to one another via a covalent single bond or via a group R.

R can be —O—, —NH—, —S—, —OC(O)—, —NHC(O)—, —N═N— or an aliphatic branched or unbranched saturated or unsaturated hydrocarbon which has from 1 to 4 carbon atoms and can be interrupted by one or more atoms or functional groups selected independently from the group consisting of —O—, —NH—, —S—, —OC(O)—, —NHC(O)— and —N═N—.

Examples of a bicyclic hydrocarbon from which the first organic compound is derived and which comprises two rings which are linked to one another via a covalent single bond or via a group R are biphenyl, stilbene, diphenyl ether, N-phenylbenzamide and azobenzene. Preference is given to biphenyl.

Furthermore, the bicyclic hydrocarbon from which the second compound is derived can be a fused ring system.

Examples are decalin, tetralin, naphthalene, indene, indane, pentalene. Preference is given to tetralin and naphthalene.

Furthermore, the bicyclic hydrocarbon from which the second organic compound is derived can have a bridged ring system.

Examples are bicyclo[2.2.1]heptane and bicyclo[2.2.2]octane, with the latter being preferred.

The polycyclic hydrocarbon from which the first organic compound is derived can likewise comprise fused and/or bridged ring systems.

Examples are biphenylene, indacene, fluorene, phenalene, phenanthrene, anthracene, naphthacene, pyrene, chrysene, triphenylene, 1,4-dihydro-1,4-ethanonaphthalene and 9,10-dihydro-9,10-ethanoanthracene. Preference is given to pyrene, 1,4-dihydro-1,4-ethanonaphthalene and 9,10-dihydro-9,10-ethanoanthracene.

If the second organic compound has more than one ring, the at least two heteroatoms can be located in one ring or in a plurality of rings.

The second organic compound is particularly preferably selected from the group consisting of

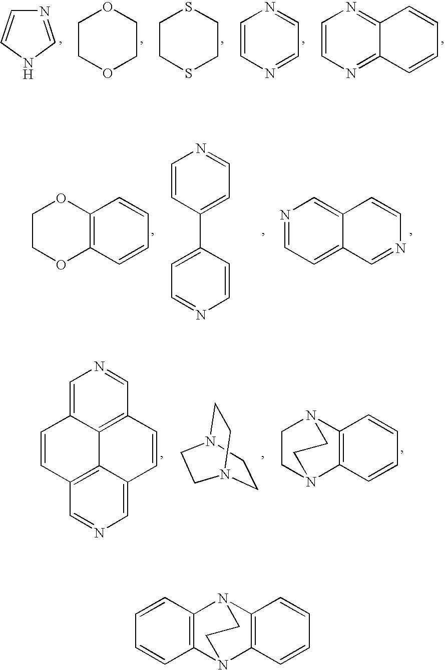

and substituted derivatives thereof.

Suitable substituents are the substituents mentioned above in general terms for the second organic compound. Particularly preferred substituents are methyl and ethyl. In particular, the substituted derivatives have only one substituent. Very particularly preferred substituted derivatives are 2-methylimidazole and 2-ethylimidazole.

The reaction in step (a) and/or (b) is preferably carried out in a temperature range from 50° C. to 160° C. The reaction is more preferably carried out in a temperature range from 55° C. to 135° C., even more preferably in the range from 60° C. to 100° C. and in particular in the range from 60° C. to 80° C. Furthermore, it is advantageous for the reaction in step (a) to take place under atmospheric pressure.

The reaction in step (a) and/or (b) in the process of the invention preferably takes place at atmospheric pressure. Thus, elevated pressure is not required for carrying out the reaction. In particular, it is not necessary to work under superatmospheric pressure in order to obtain higher specific surface areas. In particular, it is not necessary to work under solvothermal conditions. Although the reaction is carried out at atmospheric pressure, slightly superatmospheric or subatmospheric pressures can occur during the reaction due to the apparatus used. For this reason, the term “atmospheric pressure” refers, for the purposes of the present invention, to a pressure range from not more than 250 mbar below, preferably not more than 200 mbar below, atmospheric pressure to not more than 250 mbar above, preferably not more than 200 mbar above, atmospheric pressure. The actual pressure in the reaction is thus in the range indicated above. The actual pressure is more preferably equal to the atmospheric pressure.

### EXAMPLES

### Example 1

### Preparation of a Metal Organic Framework Composed of Cu-BDC-TEDA

A solution of 6.2 g of CuSO₄*5(H₂O) in 100 ml of methanol is added to a suspension of 4.2 g of terephthalic acid (BDC) in 120 ml of DMF in a glass flask provided with a stirrer. Rapid precipitation formation takes place spontaneously. The solution is stirred at 65° C. for another 6 hours. The blue precipitate is subsequently filtered off and stirred in a solution of 1.4 g of triethylenediamine (TEDA) in 160 ml of methanol at about 70° C. under reflux for 16 hours.

The product is once again filtered off and washed a number of times with methanol. The product is subsequently dried at 110° C. in a vacuum drying oven for 16 hours. This gives 5.7 g of a turquoise Cu-BDC-TEDA MOF. The surface area (N₂ sorption by the Langmuir method) is 2063 m²/g.

### Examples 2 and 3

### Reproducibility of the Synthesis

Example 1 is repeated twice. In one case, triethylenediamine from another company is used (examples 1 and 2: brand Alfa Aesar from Johnson Matthey, example 3: from Aldrich).

Products having a surface area of 2031 m²/g (example 2) and 1889 m²/g (example 3) are obtained. The synthesis is thus in principle very reproducible when the same starting materials are used. When obviously lower quality starting materials are used, differences can obviously occur. However, even in this case, very high surface area values with a deviation of less than 10% are still achieved.

The color of all samples is similar (turquoise).

### Example 4

### Preparation of a Cu-BDC-TEDA MOF in the Presence of a Large Amount (8 wt %) of HCOOH

The synthesis is carried out as in example 1 but 12.8 ml of formic acid are initially charged together with the DMF. This gives 5.2 g of a product which has a surface area of only 621 m²/g.

### Comparative Example 5

### Preparation of a Cu-BDC-TEDA MOF in the Presence of a Small Amount (2 wt %) of HCOOH

The synthesis is carried out as in example 1 but 3.2 ml of formic acid are initially charged together with the DMF. This gives 1.2 g of a product which has a surface area of only 1329 m²/g.

### Comparative Examples 6-10

### Preparation of a Cu-BDC-TEDA MOF in the Presence of an Intermediate Amount (4 wt %) of HCOOH

The synthesis is carried out as in example 1 but 6.4 ml of formic acid are initially charged together with the DMF. This gives products having the following surface areas:

| Ex. No. | N₂ surface area (Langmuir) |
|---|---|
| 6 | 1202 m²/g |
| 7 | 1777 m²/g |
| 8 | 1540 m²/g |
| 9 | 957 m²/g |
| 10 | 1475 m²/g |
| Mean | 1390 m²/g |

A mean of only 1390 m²/g is obtained. In addition, the syntheses are significantly less reproducible: The maximum downward deviation is 31%. The standard deviation is 317 m²/g (23%). The colors of the individual samples also display clearly visible differences and vary from mint green to turquoise.

1. A process for preparing a porous metal organic framework comprising a first and at least one second at least bidentate organic compound coordinated to at least one copper ion, said process comprising
(a) reacting a reaction mixture in the liquid phase comprising at least one copper compound and the first at least bidentate organic compound to form an intermediate complex comprising the at least one copper ion and the first at least bidentate organic compound, with the first at least bidentate organic compound being derived from a dicarboxylic acid and having a skeleton which is a hydrocarbon, and
(b) reacting the intermediate complex with the at least second at least bidentate organic compound, with the at least second at least bidentate organic compound being an optionally substituted monocyclic, bicyclic or polycyclic saturated or unsaturated hydrocarbon in which at least two ring carbons have been replaced by heteroatoms selected from the group consisting of N, O and S,
wherein the reaction mixture in step (a) comprises less than a 3-fold excess of formic acid based on the copper of the copper compound.

2. The process according to claim 1, wherein the copper compound is selected from the group consisting of copper(II) sulfate, copper(II) bromide, copper(II) chloride, copper(II) carbonate and hydrates thereof.

3. The process according to claim 1, wherein no formic acid is present.

4. The process according to claim 1, wherein the reaction mixture in (a) comprises less than a 3-fold excess of a monocarboxylic acid based on the copper of the copper compound.

5. The process according to claim 1, wherein no monocarboxylic acid is present.

6. The process according to claim 1, wherein the hydrocarbon is selected from the group consisting of benzene, naphthalene, biphenyl, pyrene, dihydropyrene and ethene.

7. The process according to claim 1, wherein the at least second at least bidentate organic compound is selected from the group consisting of 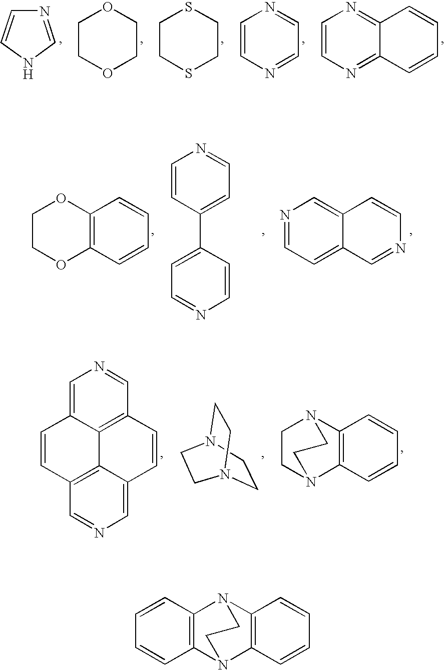
and substituted derivatives thereof.

8. The process according to claim 1, wherein said reacting in (a) is carried out in a temperature range from 50° C. to 160° C.

9. The process according to claim 1, wherein said reacting in (a) takes place under atmospheric pressure.

10. The process according to claim 1, wherein the intermediate complex is obtained by separating off the mother liquor and is reacted without further work-up in (b).
